(19) United States
(12) Patent Application Publication
(10) Pub. No.: US 2007/0267212 A1
(43) Pub. Date: Nov. 22, 2007

(54) Wiring Harness for Motor Vehicles

(76) Inventors: Otto Nachbauer, Floss (DE); Johannes Horn, Krummennaab (DE); Dietmar Volkl, Friedenfeld (DE); Thomas Keck, Weiden (DE); Oliver Grundker, Wedemark (DE); Siegfried Hofler, Hannover (DE); Stefan Nieber, Garbsen (DE); Ulrich Overhage, Garbsen (DE)

Correspondence Address: Sofer & Haroun, Suite 910, 317 Madison Ave, New York, NY, 10017, US

(21) Appl. No.: 10/557,231

(22) PCT Filed: Feb. 27, 2004
(86) PCT No.: PCT/EP04/01957

§ 371 Date: Feb. 7, 2007

(30) Foreign Application Priority Data
Mar. 5, 2003 (EP) 0320533.3

(51) Int. Cl. B60R 16/023

(52) U.S. Cl. 174/70 R; 174/98

(57) ABSTRACT

A method for operating a directory assistance system responsive to Voice over IP device requests includes the steps of receiving a directory assistance request from at least one Voice over IP device and identifying the requested information for delivery to the Voice over IP device. The requested information is formatted in accordance with a format required by the Voice over IP device and a notification message is transmitted to the Voice over IP device indicating that information relating to the directory assistance request is available. A request from a web server is received for retrieval of the requested information in response to the directory assistance request, where the web server is accessed by the Voice over IP device after receipt of the notification message. The requested information is transmitted to the Voice over IP device via the web server.

The invention relates to a wiring harness for motor vehicles, in which a number of electrical and/or optical lines that, when installed, are arranged on a motor vehicle and/or an auxiliary vehicle that may be hitched to same, for the purpose of transmitting current and/or signals between at least one controller connected to a voltage source and consumers, are combined into a unit (cf. German Patent Application DE 40 26 718 C2).

The term “consumers,” in the sense of the invention, shall be construed as including any and all units or components that are to be supplied with electric current, i.e., “current consumers.” Examples of such consumers are all components, such as headlights and taillights, of motor vehicles employed for lighting purposes, all sorts of sensors, solenoid valves, diagnostic systems, and controllers, where this list of the types of items that might be involved is exemplary only, and is not intended to be exhaustive.

Wiring harnesses combine a more or less large number of lines, where the number of lines involved will depend upon the type and class of vehicle involved and the lines will usually have differing lengths. Such wiring harnesses may be installed on passenger cars, trucks, campers, or auxiliary vehicles, such as trailers. The basic configuration of wiring harnesses will be evident from, for example, German Patent Application DE 40 26 718 C2, which has been referred to above. Furthermore, U.S. patent application Ser. No. 6,259,027 B1 depicts a compact wiring harness that has at least one substrate populated with an electronic component arranged at a location or locations along its length. The lines entering and exiting the wiring harness are connected to that component. All lines of the wiring harness, along with the substrate or substrates, are combined into a unit by tape wrapped around the aforementioned components of the wiring harness.

Modern passenger cars have several wiring harnesses that lead to various groups of consumers installed in them. The “consumers” involved are, for example, headlights, taillights, sensors, and servomotors. The front ends, rear ends, doors, or seats of passenger cars each have their own, separate, wiring harnesses. The more consumers involved and the more functions they have, the thicker will be the wiring harnesses employed, since the numbers of lines required for each will be greater.

The controller that is to activate, deactivate, and monitor the operation of consumers will also have to be more elaborately designed and/or be designed to be upgradeable if more functions are to be involved. Controllers are equipped with “functional elements” in order to implement the necessary functions. Included among these functional elements are, for example, electrical and electronic components, such as diodes, resistors, printed circuits, functional modules, and systems required for use on, for example, trucks and their trailers. These functional elements are used for, for example, completing circuits, deactivating, detecting, and controlling the operation of antilocking braking systems (ABS), electrical braking systems (EBS), brake-pad wear indicators (BWI), lighting systems, level-regulation systems, reversing warning systems, diagnostic systems, systems for checking the operation of vehicles' brakes, systems for checking tire pressures, and general-information systems. The associated controllers will have to be elaborately designed if they are to be able to handle all of the various functions provided by consumers whenever required.

The problem addressed by the invention is configuring the wiring harness mentioned at the outset hereof in a simpler manner while simultaneously providing opportunities for simplifying the complement of equipment of the controller to which it is to be connected.

The invention solves that problem by providing that
one end of every line of a first unit of lines combined by a common sheath, whose other ends are intended to be connected to the controller, are inserted into the housing of a distributor such that ingress of moisture will be precluded,
one end of every line of at least two, mutually discrete, continuation units, where the lines involved are also combined by a common sheath and their other ends are intended to be connected to consumers, is inserted into the housing of the distributor such that ingress of moisture will be precluded,
the conductors of the lines of both the first unit and the continuation units are electrically interconnected within the housing following prescribed rules, and
the entire housing is designed to be waterproof.

This wiring harness is split into two segments by the distributor such that a space-saving configuration, combined with less materials usage, result. Fewer lines may be arranged in its forward segment, i.e., that implemented by the first unit, since consumers that require the same function from the controller may be jointly connected to an associated line of the first unit in the distributor via the latter's line arranged in one of the continuation units. All such lines may be combined in a continuation unit in the second segment of the wiring harness that leads to unified group of consumers, and will thus all have about the same length. The continuation units may thus beneficially have differing lengths, which will further simplify the wiring harness requiring less materials usage. Since the entire housing of the distributor is waterproof, such a wiring harness may be readily employed under severe ambient conditions, for example, for generating connections to, or within, truck trailers.

At least one functional element affecting the operation of, or completing circuits for transmitting functions to, interconnected consumers may also be arranged within the distributor's waterproof housing. Such a functional element will then no longer need to be accommodated in the controller, which will allow more simply configuring the latter. The distributor may also utilized, or readied, for equipping the wiring harness with functions that might be needed later, which means that it will no longer be necessary to reserve space in the controller for accommodating the distributor. The functional elements, whether in the form of discrete components, such as, for example, decoupling diodes, or in the form of such combined on printed circuits, may be accommodated in the housing of the distributor. The wiring harness may be highly flexibly configured, since it incorporates the distributor.

In the case of a preferred embodiment, the housing of the distributor encloses a hollow chamber. The terminals for connecting the various lines and any functional elements that may be present will then essentially be surrounded by air, instead of embedded in materials impervious to moisture. The electrical parameters of the functional elements will remain unaffected thereby, and will retain their optimal values. Any heat generated within the distributor will then also have no significant effects on the functional elements.

In the case of another embodiment, the distributor may also have a housing filled with a highly porous, foamed, insulating material, i.e., an insulating material having a high air content, in which the functional element involved is embedded. The latter will then be protected against mechanical stresses, such as vibrations and shocks due to vehicle motions, in a simple manner.

The figures depict a sample embodiment of the object of the invention.

Those figures depict:

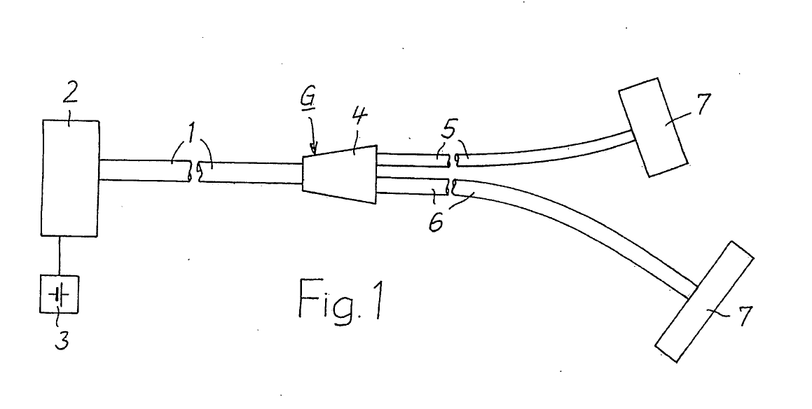

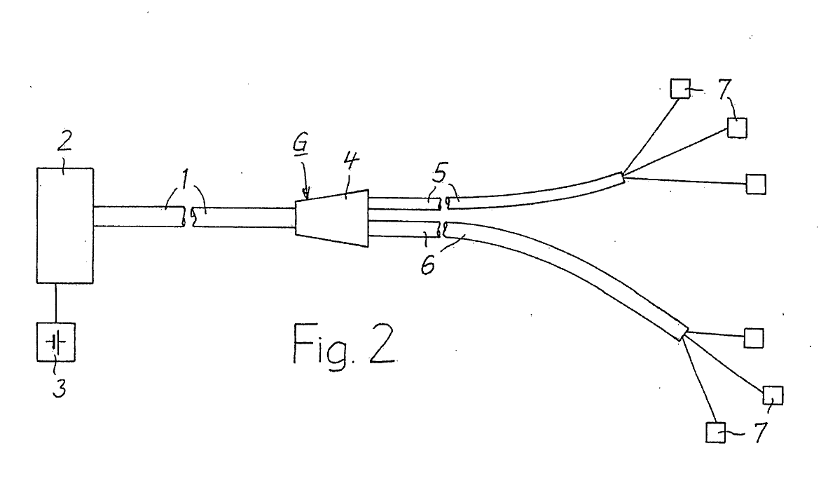

FIGS. 1 and 2: Schematized views of a wiring harness according to the invention designed for use in two differing applications connected to a controller and consumers of a vehicle.

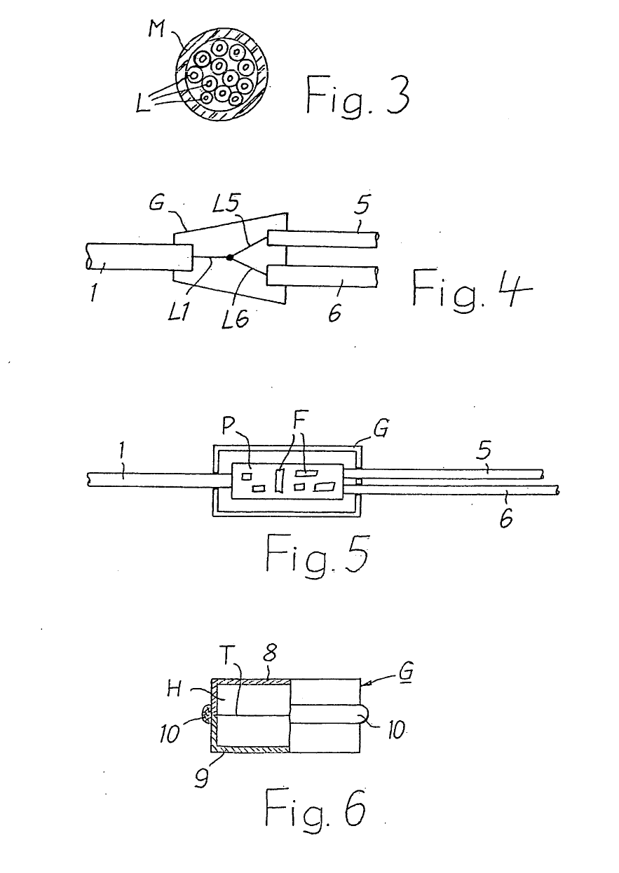

FIG. 3: A sectioned view of a unit of the wiring harness.

FIG. 4: An enlarged view of a portion of the interior of a distributor on the wiring harness.

FIG. 5: An embodiment of a more elaborate distributor than that shown in FIG. 4.

FIG. 6: A view of the housing of the distributor, drawn on an even larger scale.

A wiring harness k schematically depicted in FIG. 1 is intended for installation on, for example, a passenger car (not shown), has a large number of lines L (cf. FIG. 2) that are combined into a first unit 1 by a common sheath. The lines L present may be electrical and/or optical lines. One end of the wiring harness K is connected to a controller 2 that is connected to the battery 3 of the passenger car, which serves as a voltage source. The first unit 1 of the wiring harness K terminates on a distributor 4 that has a housing G that is preferably fabricated from a durable plastic, such as, for example, polyurethane.

In the case of the sample embodiment shown, two continuation units 5, 6 exit the distributor 4, or its housing G. However, more than two continuation units may also be connected to the distributor 4. A number of lines L are combined by a common sheath within every continuation unit 5, 6. A unit 5 or 6 should contain at least one line L. Each of the units 5, 6 is connected to a consumer 7, indicated by a box, as shown in FIG. 1. The consumers involved may be, for example, diagnostic equipment or another controller, from which continuation lines leading to other consumers proceed.

As shown in FIG. 2, the lines L of the continuation units 5, 6 are connected to consumers 7 arranged on a passenger car by, for example, plug-in connectors. It will be beneficial if those lines L leading to a group of consumers 7 that are situated close to one another are combined. The units 5, 6 may thus have differing lengths.

As mentioned above, the lines L of the wiring harness K may be electrical or optical lines. Their electrical conductors or optical fibers are encased in insulating sheaths. Each of the units 1, 5, 6 contains a number of lines L corresponding to the demands imposed thereon. The latter are combined by a common sheath that is preferably an extruded sheath M fabricated from a mechanically rugged, chemically resistant, insulating material. That sheath M consists of, for example, polyurethane.

The distributor 4 is arranged in the wiring harness K such that, following installation of the latter in a passenger car, it will may be installed as close as practicable to the location where a splitting, or distribution, of the lines L makes sense. The first unit 1 of the wiring harness K will thus be configured such that it will be as long as possible, and will be inserted into the housing G of the distributor such that ingress of moisture will be precluded. The same also applies to the continuation units 5, 6. The entire housing G is waterproof, once the wiring harness K has been fully assembled.

The wiring harness K may beneficially be employed for wiring a truck trailer, in which case, the controller 2 will preferably be arranged in the trailer. The latter is connected to the onboard network of the tractor by at least one, standard, interconnecting line in order to generate an operational arrangement. At least one jack that is connected to the tractor's onboard network is present on the tractor for that purpose. The interconnecting line is terminated by a standard connector that may be inserted into the jack whenever necessary.

The simplest embodiment of the distributor 4 has a purely distributive function, i.e., referring to the portion thereof shown in FIG. 3, for example, jointly connecting a line L5 of continuation unit 5 and a line L6 of continuation unit 6 to a line L1 of the first unit 1, or providing that the former may be jointly connected to the latter, which will be possible if the same function, such as, for example, connection to a current supply, is needed by those consumers 7 that are connected, or are to be connected, to lines L5 and L6.

In the aforementioned sense, two or more lines L of the continuation units 5, 6 may be jointly connected to a line L of the first unit 1 within the distributor 4. The same also applies to the lines of further continuation units, in cases where more than two continuation units are connected to the distributor 4.

The distributor 4 may also be utilized for accommodating functional elements F that are needed for affecting the operation of consumers 7 or completing circuits that transmit functions of the controller 2. The functional elements F involved may be discrete elements, such as, for example, diodes employed for decoupling devices from voltages. However, several functional elements F in the form of a printed circuit may also be arranged on a board P situated in the waterproof housing G of the distributor 4.

In the case of a preferred embodiment, the housing G of the distributor 4 consists of two parts 8, 9 separated by a joint T that enclose a hollow chamber H and may be joined by means of fasteners. However, the housing G might also consist of more than two parts. The board P is arranged in the hollow chamber H. The former is essentially surrounded by air when installed in the latter. The housing G is sealed such that it will be waterproof by, for example, spraying on a circumferential bead of sealing compound 10 extending around the joint T between its two parts 8, 9.

The distributor 4 is incorporated into the wiring harness K during the latter's manufacture. The lines L of the units 1, 5, 6, which should be available in the necessary lengths, might initially be connected to the board P, or its functional elements F, for that purpose. The housing G is then installed in order to enclose the board P and the ends of the units 1, 5, 6, where, in the case of a preferred embodiment, the two parts 8, 9 of the former are emplaced on opposing sides of the board P and the units 1, 5, 6 and brought together until, for example, they are joined together by flexible, latching fasteners. Holders for fastening the board P in place may be attached to least one of the parts 8, 9 of the housing G. Once the housing G has been closed, the joint T between its two parts 8, 9 is sealed all around its circumference by spraying a material that is impervious to moisture thereon, thereby creating the sprayed-on, circumferential bead of sealing compound 10. The housing G will then be sealed such that it will be waterproof.

For use in certain applications involving appropriately configured functional elements F, the housing G may also be filled with a highly porous, insulating material, in which the board P is embedded. The board P, along with its functional elements F, will then be better protected against mechanical stresses, such as shocks and vibrations, which can hardly be avoided during the operation of passenger cars. The distributor 4 will thus also be further mechanically stabilized. There will be no significant increase in its weight due to the highly porous, insulating material, in view of the latter's high air content.

1. A wiring harness for motor vehicles comprising:
a number of electrical and/or optical lines that, when installed, are arranged on a motor vehicle and/or an auxiliary vehicle that may be hitched to the same, for the purpose of transmitting current and/or signals between at least one controller connected to a voltage source and consumers, are combined into a unit, wherein
one end of every constituent of a first unit of lines combined by a common sheath, whose other ends are intended to be connected to a controller, is inserted into a housing of a distributor such that ingress of moisture is precluded;
one end of every constituent of at least two, mutually discrete, continuation units of said lines that are also combined by said common sheath and whose other ends are intended to be connected to consumers, is inserted into the housing of the distributor such that the ingress of moisture is precluded; and
the conductors of the lines of both the first unit and the continuation units are electrically interconnected within the housing following prescribed rules and the entire housing is waterproof.

2. A wiring harness according to claim 1, wherein at least one functional element for affecting the operation of, monitoring, and/or controlling consumers is installed in the distributor.

3. A wiring harness according to claim 2, where in several functional elements are jointly arranged in a printed circuit on a board situated in the housing.

4. Employment of a wiring harness according o any claim 1 on a truck trailer.
